(19) United States
(12) Patent Application Publication
(10) Pub. No.: US 2015/0127472 A1
(43) Pub. Date: May 7, 2015

(54) FUTURE DECISIONING FOR CREATIVE SLOTS

(71) Applicant: LiveIntent, Inc., New York, NY (US)

(72) Inventors: Matthew Rosenbach Keiser, New York, NY (US); Jerome Charles Sandoval, New York, NY (US)

(21) Appl. No.: 14/507,066

(22) Filed: Oct. 6, 2014

Related U.S. Application Data
(60) Provisional application No. 61/898,701, filed on Nov. 1, 2013.

(51) Int. Cl. G06Q 30/02

(52) U.S. Cl. CPC G06Q 30/0275
USPC 705/14.71

(57) ABSTRACT

A future decisioning module receives, from a user agent, a call requesting a creative for a first slot of the plurality of slots in a template. The future decisioning module generates bid requests for each of the plurality of slots and receives, from one or more bidders, responses to the bid requests, the responses comprising prices for the plurality of slots. The future decisioning module performs a yield optimization based on the responses to the bid requests to determine creatives for each of the plurality of slots that will optimize a payout (or value) for the template and serves, to the user agent, the determined creatives for each of the plurality of slots.

This application claims the benefit of U.S. Provisional Application No. 61/898,701 filed Nov. 1, 2013, the entire contents of which are hereby incorporated by reference herein.

### TECHNICAL FIELD

This disclosure relates to the field of on-line advertising, including customer relationship management, marketing automation and lead management, and, in particular, to future decisioning for creative slots.

### BACKGROUND

Much on-line media content is offered to users free of charge and subsidized through on-line advertising. On-line advertising can include advertising messages conveyed using text, logos, animations, videos, photographs or other graphics. Some examples of on-line advertisements include web banners, email messages, frame ads, pop-up ads, floating ads, expanding ads, trick banners, interstitial ads, and text ads. These on-line advertisements can be presented to a user in a variety of ways including on a web-page, through email, through social media applications, or on a mobile device. In some cases, where multiple advertisements are displayed to the user at once, there may be a latency associated with determining what advertisements to display.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary network architecture in which embodiments of the present disclosure may be implemented.

FIG. 2A is a block diagram illustrating a future decisioning module, according to some embodiments.

FIG. 2B is a block diagram illustrating an email advertising template, according to some embodiments.

FIG. 2C is a block diagram illustrating tag repository, according to some embodiments.

FIG. 3 is a flow diagram illustrating a method for template creation, according to some embodiments.

FIG. 4 is a flow diagram illustrating a method for future decisioning, according to some embodiments.

FIG. 5 is a block diagram illustrating an exemplary computer system, according to some embodiments.

### DETAILED DESCRIPTION

Embodiments are described for future decisioning for creative slots. In one embodiment, a future decisioning module in a server can receive a request from user agent for a creative to fill a slot in a template associated with piece of content provided by a publisher. The content may include, for example, a web page, an email or some other piece of content. The template may include multiple slots where an advertisement or other piece of content can be displayed or linked to. In one embodiment, in response to receiving the request for a creative for one ad slot (e.g., a first ad slot, which may be any ad slot in the template), the future decisioning module can generate bid requests for all ad slots in the template, even though requests for the other ad slots have not yet been received. The future decisioning module can conduct an auction among advertisers and receive bid responses from the advertisers. The bid responses may include a price that each advertiser is willing to pay to have their creative (e.g., advertisement, marketing message, content) displayed in a particular slot or a value, which may include any way to rank the importance or engagement of having the creative appear in the particular slot. The future decisioning module can perform a yield optimization process to determine a combination of bids that will result in a highest payout (yield, conversion rate, click rate, etc.) to the publisher for the template. The future decisioning module can then serve the appropriate creative(s) to the user agent for display with the content. In one embodiment, the yield optimization process may optimize, maximize, increase or improve a payout for the template or a value of the template to the publisher.

By identifying all of the ad slots associated with a template in response to receiving an ad call for only one of the slots, or at least before ad calls were received for all of the ad slots, the future decisioning module can begin the yield optimization process and corresponding auction sooner than a system which has to wait for ads calls for each individual ad slot. This can reduce the latency between when the ad call is issued by the user agent and when the requested advertisements are received. In addition, by auctioning all of the ad slots at once, the yield optimization can be more effective in determining what combination of creatives will maximize or optimize the payout (yield, conversion rate etc.) to the publisher for a given template.

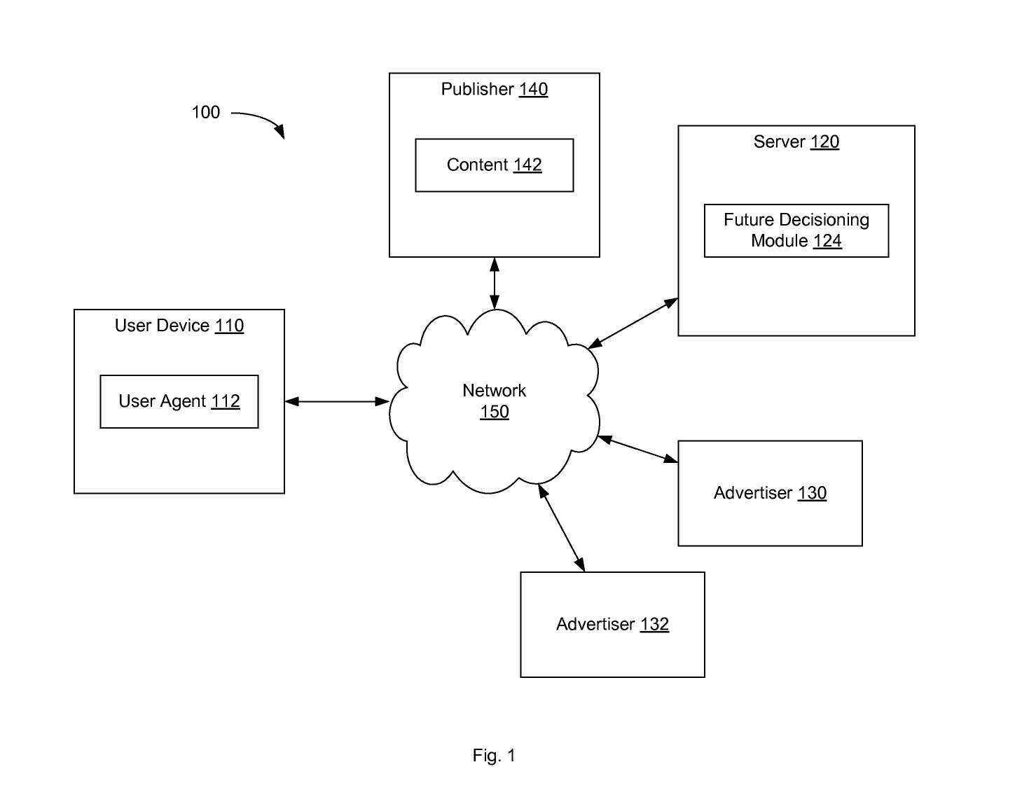

FIG. 1 is a block diagram illustrating an exemplary network architecture in which embodiments of the present disclosure may be implemented. The network architecture 100 can include one or more user devices 110 communicating with one or more servers, such as server 120 over one or more networks 150, according to one embodiment. Network 150 can be a local area network (LAN), a wireless network, a telephone network, a mobile communications network, a wide area network (WAN), such as the Internet, or similar communication system. User device 110 may be any type of computing device including a desktop computer, laptop computer, mobile communications device, cell phone, smart phone, hand-held computer, tablet computer, or similar computing device. User device 110 may be variously configured with different features to enable viewing of multimedia content, such as images, videos, songs, etc., webpages, email, or other content.

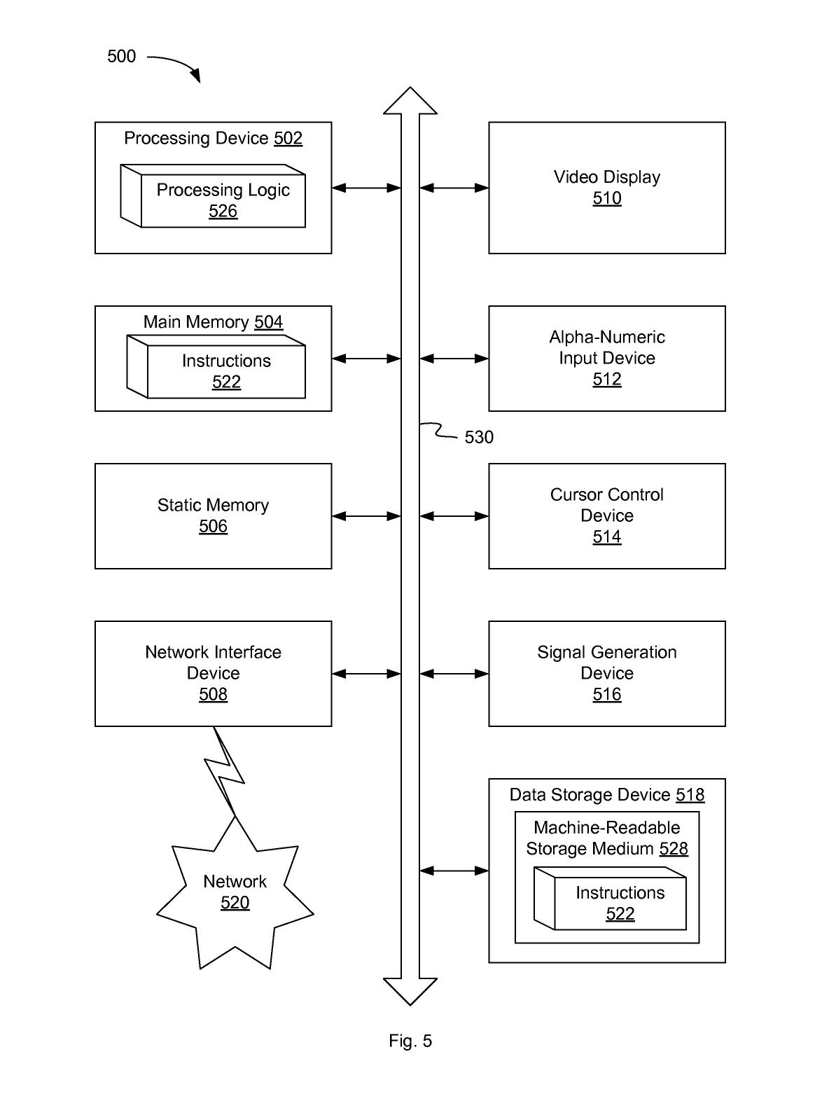

Server 120 may include a network-accessible server-based functionality, various data stores, and/or other data processing equipment. Servers 120 may be implemented by a single machine or a cluster of machines. Server 120 may be hosted, for example, by computer system 500 of FIG. 5. In one embodiment, server 120 is an advertising server that stores advertisements used in online marketing campaigns and delivers them to users. In another embodiment, server 120 is some other server that facilitates communication between user device 110, publisher 140, advertisers 130, 132 and/or some other advertising server.

For example, a user of user device 110 can view a web page or email sent by publisher 140, using a web browser, email client application or other program running on user device 110. Collectively, the program used to view content on user device 110 may be referred to as user agent 112. Publisher 140 can deliver web pages to user device 110 or another client device using for example the Hypertext Transfer Protocol (HTTP). In another embodiment, publisher 140 may be an email server that delivers emails to user device 110. In another embodiment, publisher 140 may instruct some other server to serve web pages or send emails to user device 110.

In one embodiment, server 120 includes future decisioning module 124. Future decisioning module 124 can receive a request from user agent 112 for a creative to fill an advertisement slot in an advertisement template associated with piece of content 142 provided by publisher 140. The content 142 may include, for example, a web page, an email or some other piece of content. The template may include multiple slots where an advertisement or other piece of content can be displayed or linked to. In one embodiment, in response to receiving the request for a creative for one ad slot (e.g., a first ad slot, which may be any ad slot in the template), future decisioning module 124 can generate bid requests for all ad slots in the template, even though requests for the other ad slots have not yet been received. Future decisioning module 124 can conduct an auction among advertisers, such as advertisers 130 and 132, and receive bid responses from the advertisers 130 and 132. In the illustrated embodiment, only two advertisers 130 and 132 are shown. It should be understood that in other embodiments, there may be any other number of advertisers, including more or fewer advertisers, and that the auction may be conducted among all of the advertisers or among some subset of the advertisers. For ease of discussion, future references herein will be made to advertisers 130 and 132. The bid responses may include a price that each advertiser is willing to pay to have their creative (e.g., advertisement) displayed in a particular ad slot. Future decisioning module 124 can perform a yield optimization process to determine a combination of bids that will result in a highest payout (yield, conversion rate, etc.) to the publisher 140 for the template. Future decisioning module 124 can then serve the appropriate creative to user agent 112 for display with the content 142. In other embodiments, future decisioning module 124 can run on some other server, or on some other separate computing device. In another embodiment, future decisioning module 124 can instruct some other advertisement server to serve the appropriate creative to user agent 112. Some embodiments of future decisioning module 124 are discussed in more detail below.

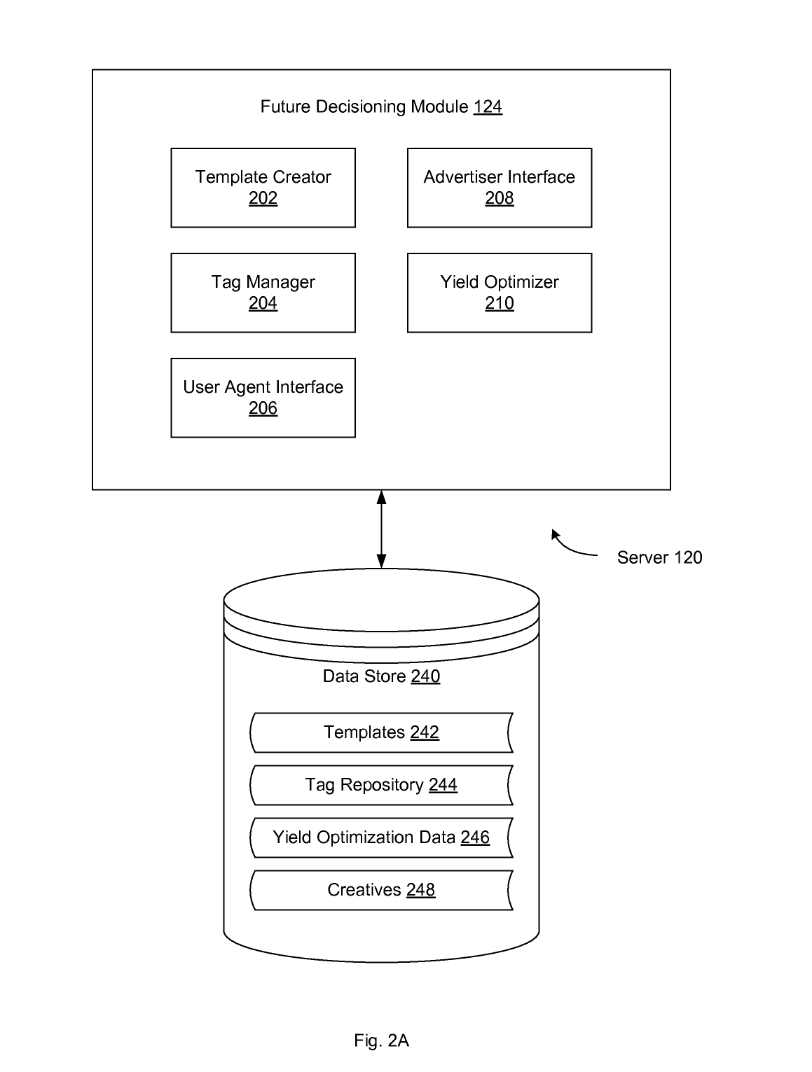

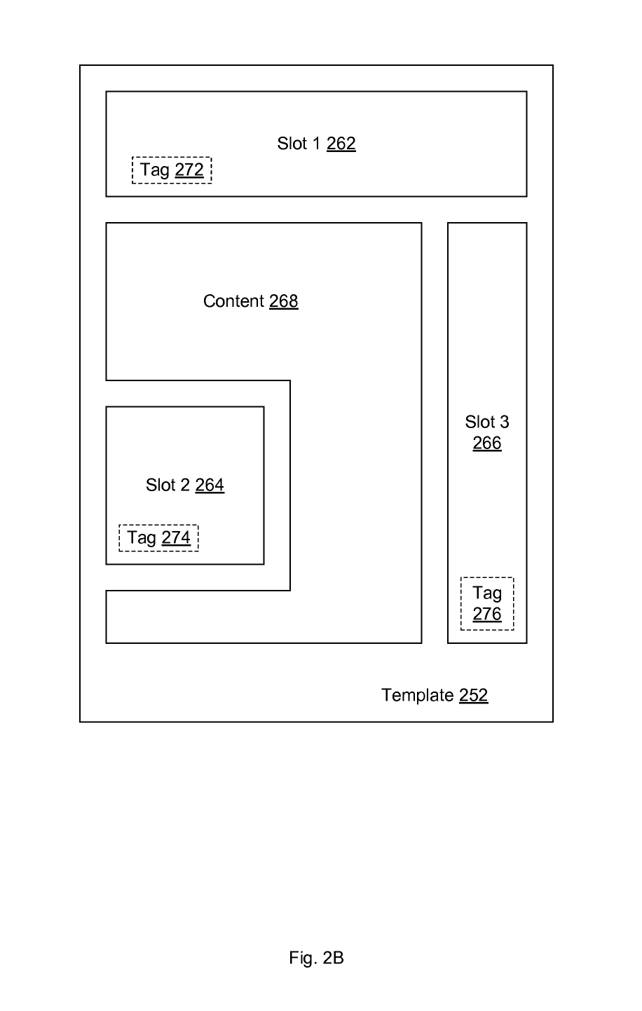

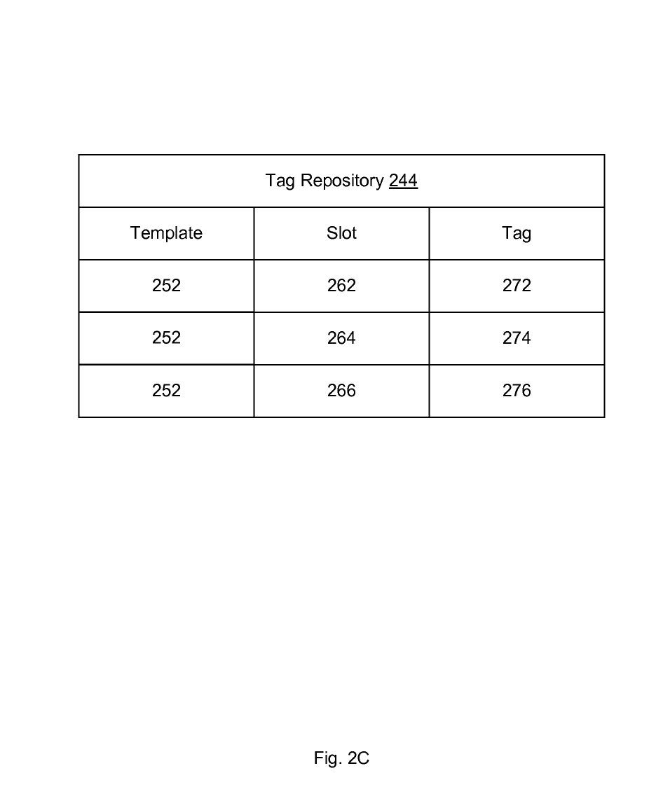

FIG. 2A is a block diagram illustrating future decisioning module 124, according to some embodiments of the present disclosure. In one embodiment, future decisioning module 124 includes template creator 202, tag manager 204, user agent interface 206, advertiser interface 208, and yield optimizer 210. This arrangement of modules may be a logical separation, and in other embodiments, these modules or other components can be combined together or separated in further components, according to a particular embodiment. In one embodiment, storage device 240 is connected to future decisioning module 124 and includes templates 242, tag repository 244, yield optimization data 246, and creative 248. In one embodiment, server 120 may include future decisioning module 124 and storage device 240. In another embodiment, storage device 240 may be external to server 120 and may be connected to server 120 over a network or other connection. In other embodiments, server 120 may include different and/or additional components which are not shown to simplify the description. Storage device 240 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

FIG. 2B is a block diagram illustrating an email advertising template 252, according to some embodiments. In one embodiment, template 252 includes ad slots 262, 264, 266 and content space 268. In other embodiments, other templates may have some other number or arrangement of ad slots and content space. In other embodiments, other templates may have only ad slots, without including any content space. In one embodiment, ad slots 262, 264, 266 may have different sizes and shapes in order to accommodate different creatives. The creatives defined for ad slots 262, 264, 266 may include, for example, web banners, frame ads, pop-up ads, floating ads, expanding ads, trick banners, interstitial ads, text ads, or any other type of creative.

Referring back to FIG. 2A, in one embodiment, template creator 202 provides a template creation interface to allow for the creation of an advertisement template 252. The template creation interface allows a publisher 140 to define the number, location, size, etc. of ad slots 262, 264, 266 in the template. The template creation interface may be, for example, a graphical user interface (GUI), a command line interface, or some other type of interface. Template creator 202 may provide the template creation interface to publisher 140 and receive an advertisement template 252 from the publisher 140. In another embodiment, template creator 202 may receive information defining the layout of ad slots 262, 264, 266 in the template 252. Template creator 202 may store the received template 252 in data store 240 as one of templates 242 and may associate the template 252 with a piece of content 142 at the request of publisher 140.

In one embodiment, tag manager 204 assigns tags 272, 274, 276 to each of the ad slots 262, 264, 266 in a template 252. The tags 272, 274, 276 may uniquely identify each ad slot 262, 264, 266 and associate each ad slot 262, 264, 266 with the template 252. In this manner, an individual ad slot 262 can be identified as part of a given template 252 and the additional ad slots 264, 266 associated with the template can also be identified. In one embodiment, a tag may include a set number of binary bits or bytes. In other embodiments, a tag may include human readable text, numbers, symbols or other characters. In one embodiment, each ad slot 262, 264, 266 in template 252 has a unique tag 272, 274, 276. In another embodiment, each ad slot 262, 264, 266 in template 252 is assigned the same tag.

In one embodiment, user agent interface 206 detects that a piece of content 142 (e.g., an email, webpage) including an advertisement template 252 is sent to a user agent 112 on user device 110. The email itself may be sent by publisher 140 or some other email server, rather than by future decisioning module 124. User agent interface 206 may receive an ad call from the user agent 112 requesting a creative for a first ad slot of the multiple ad slots in the template 252. In response, user agent interface 206 can notify tag manager 204, which in turn can identify the remaining ad slots in template 242 based on the tag. In one embodiment, tag repository 244 may include a listing of each template and the associated ad slots. FIG. 2C is a block diagram illustrating tag repository 244, according to some embodiments. In one embodiment, tag repository 244 can be used to associate a particular tag 272 with the corresponding ad slot 262 and template 252. Upon determining the template 252 associated with the particular tag 272, tag manager 204 can determine other entries in tag repository 244 for the same template 252 and identify the tags 274, 276 associated with the remaining ad slots 264, 266 in the template 252. Alternatively, the tag itself may identify one of templates 242 (e.g., may include an identifier of the corresponding template 252).

In one embodiment, advertiser interface 208 generates bid requests for each of the advertisement slots 262, 264, 266 in the template 252, even though an ad call for only one ad slot 272 has been received. Advertiser interface 208 may send the bid requests to advertisers 130 and 132, thereby initiating an auction for the multiple ad slots 262, 264, 266 in the template 252. In response to the bid requests, advertiser interface 208 may receive responses to the bid requests, including prices the advertisers 130 and 132 are willing to pay for each ad slot, how many ad slots they wish to purchase or reserve, etc. The prices may be defined on a cost per mille (CPM) basis, calculated using a click-through rate, a conversional goal, or some other metric.

In one embodiment, yield optimizer 210 performs a yield optimization based on the responses to the bid requests to determine creatives 248 for each of the ad slots in the template that will maximize or optimize a payout to the publisher 140 for the template. In one embodiment, the yield may be affected by such factors as the price an advertiser is willing to pay, how many ad slots an advertiser is willing to purchase or otherwise reserve, how many advertisers are willing to purchase a given slot, the basis on which the cost is defined, or other factors. Yield optimizer 210 may perform calculations based on these factors and store the results as yield optimization data 246. In one embodiment, yield optimizer 210 may consider the needs and constraints of publisher 140 (e.g., yield optimization), the needs and constraints of advertisers 130 and 132 (e.g., click-through-rate or performance optimization), or some combination thereof in a low latency yield optimization process. Based on the yield optimization, user agent interface 206 may select creatives 248 provided by advertisers 130 and 132 and serve those creative 248 to user agent 112 to be displayed in the designated ad slots 262, 264, 266 of the template 252 associated with the piece of content 142 provided by publisher 140.

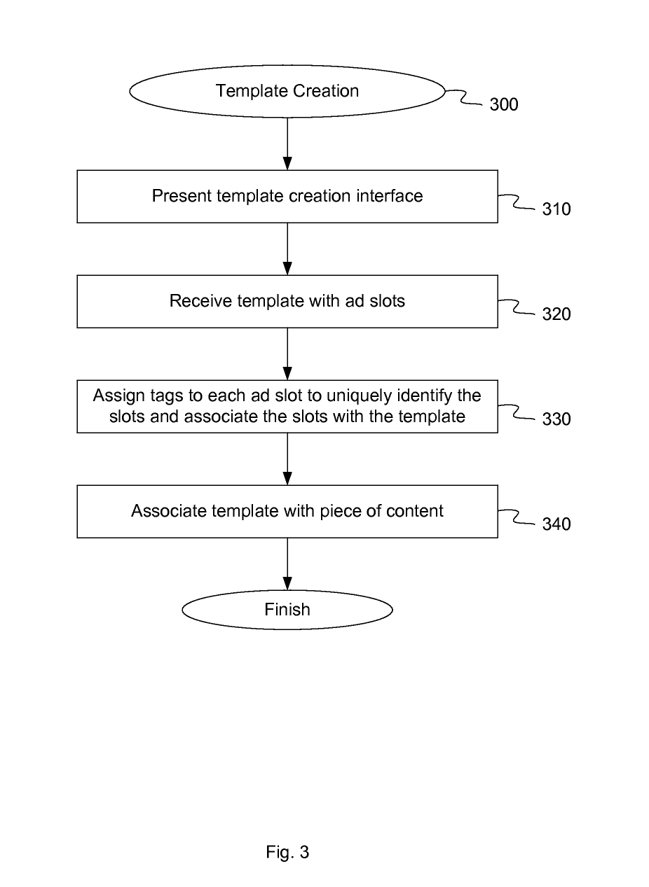

FIG. 3 is a flow diagram illustrating a method for creating an advertisement template with multiple slots, according to some embodiments. The method 300 may be performed by processing logic that comprises hardware (e.g., circuitry, dedicated logic, programmable logic, microcode, etc.), software (e.g., instructions run on a processing device to perform hardware simulation), or a combination thereof. The method 300 can allow a publisher to create an advertisement template used to display advertisements in designated slots in connection with a piece of content. In one embodiment, method 300 may be performed by future decisioning module 124, as shown in FIGS. 1 and 2A.

Referring to FIG. 3, at block 310, method 300 presents a template creation interface. In one embodiment, template creator 202 provides a template creation interface to allow for the creation of an advertisement template. The template creation interface allows a publisher 140 to define the number, location, size, etc. of ad slots in the template.

At block 320, method 300 receives a template with multiple ad slots. Template creator 202 may receive an advertisement template from the publisher 140 defining the layout of ad slots in the template. Template creator 202 may store the received template in data store 240 as one of templates 242. In another embodiment, rather than receiving the template, future decisioning module 124 instead receives an indication of which ad slots are associated with a particular template to be used by publisher 140. In this case, publisher 140 may create the template itself, without interaction with future decisioning module 124, and may itself assign tags 272, 274, 276 or some other unique identifier to the ad slots in the template that, at a minimum, identify the ad slots as being associated with one another or with the same template.

At block 330, method 300 assigns tags to each ad slot in the template that uniquely identify the ad slots and associate the slots with the template. In one embodiment, tag manager 204 assigns tags to each of the ad slots in a template. The tags may uniquely identify each ad slot and associate each ad slot with the template. In this manner, an individual ad slot can be identified as part of a given template and the additional ad slots associated with the template can also be identified.

At block 340, method 300 associates the template with a piece of content. In one embodiment, template creator 202 may associate the template with a piece of content 142 at the request of publisher 140.

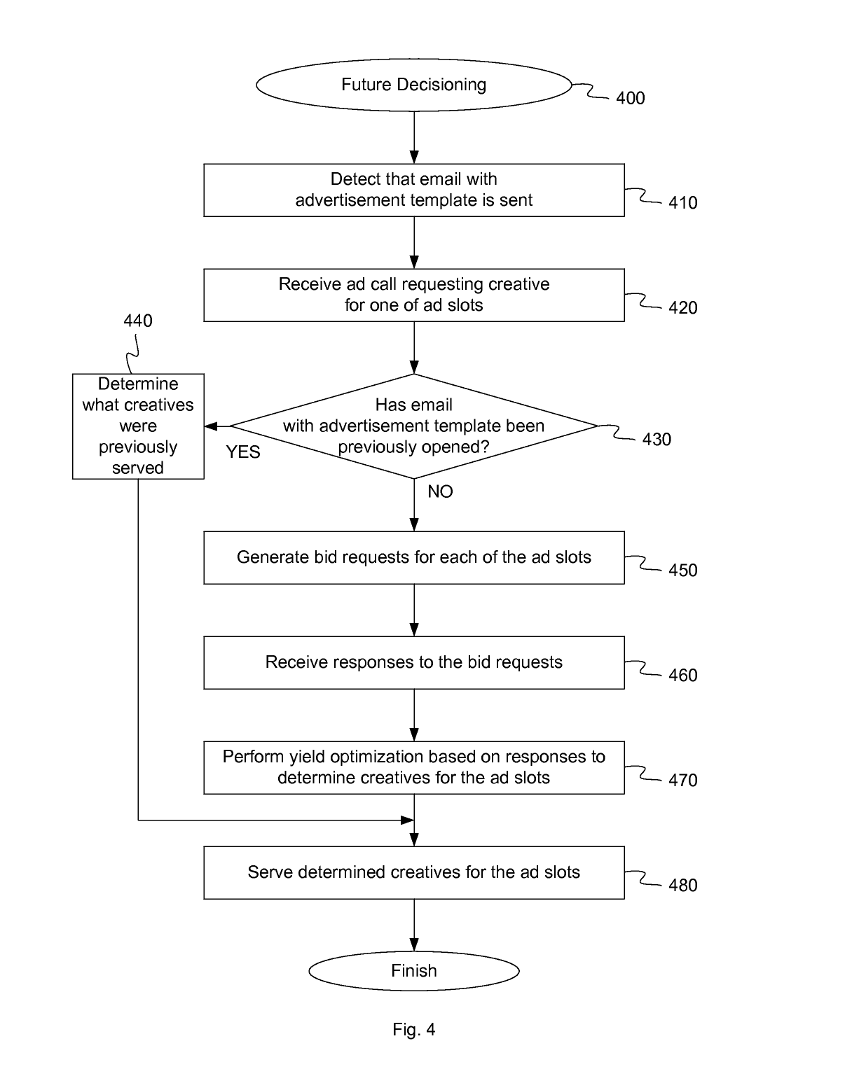

FIG. 4 is a flow diagram illustrating a method for future decisioning, according to some embodiments. The method 400 may be performed by processing logic that comprises hardware (e.g., circuitry, dedicated logic, programmable logic, microcode, etc.), software (e.g., instructions run on a processing device to perform hardware simulation), or a combination thereof. The method 400 can preemptively hold an auction for ad slots in a template prior to receiving requests for all of the ad slots and determine a combination of creatives that will optimize or at least increase or improve the yield on behalf of the publisher. In one embodiment, method 400 may be performed by future decisioning module 124, as shown in FIGS. 1 and 2A.

Referring to FIG. 4, at block 410, method 400 detects that an email with an advertisement template has been sent. In one embodiment, user agent interface 206 detects that a piece of content 142 (e.g., an email, webpage) including an advertisement template 252 to a user agent 112 on user device 110. In other embodiment, block 410 is optional and it is not required for future decisioning module 124 to detect the sending of the email.

At block 420, method 400 receives an ad call requesting a creative for a first ad slot in the template. User agent interface 206 may receive an ad call from the user agent 112 requesting a creative for a first ad slot 262 of the multiple ad slots in the template 252. The ad call may be initiated when a user opens the received email and enables the viewing of images in the email (if necessary). User agent 112 may begin making ad calls to server 120 for potentially any ad slot 262, 264, 266 in the email. Each ad slot may have a separate ad call and the ad calls may be made at different speeds and in any order. The received ad call may include the tag 272 associated with the first ad slot 262. In response, user agent interface 206 can notify tag manager 204, which in turn can identify the remaining ad slots 264, 266 in template 252 based on the tags 272, 274, 276 using tag repository 244. In one embodiment, tag repository 244 may include a listing of each template 252 and the associated ad slots 262, 264, 266 and tags 272, 274, 276. Alternatively, the tag itself may identify one of templates 242.

At block 430, method 400 determines whether the email with the advertisement template 252 has been previously opened by the user agent 112. Tag manager 204 may maintain records in tag repository 244 indicating whether or not a creative has been served for a particular combination of the user agent 112, piece of content 142, template 242, and ad slot 262. Tag manager 204 can consult these records to make the determination.

If the email has been previously opened, at block 440, method 400 determines what creatives were previously served. The same records may include an indication of which creatives were served before. For example, tag repository 244 may include an indication of the creative served to user agent 112, with piece of content 142, including template 242, and for ad slot 262. If there are differences in this combination, for example, if the request comes from a different user agent 112, or the request is for a different ad slot 264, then tag repository 244 may not include a previously served creative.

At block 480, method 400 serves the determined creatives for the ad slots. User agent interface 206 may serve the identified creative to user agent 112 for display in the template with the content. In one embodiment, the same creative is served any time a request is received for the same combination of user agent 112, piece of content 142, template 242, and ad slot 262. In another embodiment, the same creative may only be served during a specific period of time from when then email was sent. If that period of time has expired, future decisioning module 124 may select a new creative for the ad slot as described below.

If the email has not been previously opened, at block 450, method 400 generates bid requests for each of the ad slots 262, 264, 266 in the template 252. In one embodiment, advertiser interface 208 generates bid requests for each of the advertisement slots 262, 264, 266 in the template 252, even though an ad call for only one ad slot 262 has been received. Advertiser interface 208 may send the bid requests to advertisers 130 and 132, thereby initiating an auction for the multiple ad slots in the template.

At block 460, method 400 receives responses to the bid requests from advertisers 130 and 132. In response to the bid requests, advertiser interface 208 may receive responses to the bid requests including prices the advertisers 130 and 132 are willing to pay for each ad slot, how many ad slots they wish to purchase or reserve, etc. The prices may be defined on a cost per mille (CPM) basis, calculated using a click-through rate, a conversional goal, or some other metric.

At block 470, method 400 performs yield optimization based on the responses to determine a combination of creatives for the ad slots that will maximize or optimize a payout to the publisher 140 for the advertisement template 252. In one embodiment, yield optimizer 210 performs a yield optimization based on the responses to the bid requests to determine creatives 248 for each of the ad slots 262, 264, 266 in the template 252 that will maximize or optimize a payout to the publisher 140 for the template 252. In one embodiment, the yield may be affected by such factors as the price an advertiser is willing to pay, how many ad slots an advertiser is willing to purchase or otherwise reserve, how many advertisers are willing to purchase a given slot, the basis on which the cost is defined, or other factors. Yield optimizer 210 may perform calculations based on these factors and store the results as yield optimization data 246.

At block 480, method 400 serves the determined creates for the ad slots. Based on the yield optimization, user agent interface 206 may select creatives 248 provided by advertisers 130 and 132 and serve those creatives 248 to user agent 112 to be displayed in the designated ad slots of the template 252 associated with the piece of content 142 provided by publisher 140.

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a user device, such as user device 110, or of a server, such as server 120, running future decisioning module 124.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium 528, on which is stored one or more set of instructions 522 (e.g., software) embodying any one or more of the methodologies of functions described herein. The instructions 522 may also reside, completely or at least partially, within the main memory 504 and/or within the processing device 502 during execution thereof by the computer system 500; the main memory 504 and the processing device 502 also constituting machine-readable storage media. The instructions 522 may further be transmitted or received over a network 520 via the network interface device 508.

The machine-readable storage medium 528 may also be used to store instructions to perform a method for future decisioning, as described herein. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the media server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the web server or media server.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method for a server computer system comprising:
receiving, from a user agent, a call requesting a creative for a first slot of a plurality of slots in a template, the template defining a layout of the plurality of slots;
generating a bid request for each of the plurality of slots in the template;
receiving, from one or more bidders, responses to the bid requests, each response comprising a price a bidder is willing to pay to display a creative in one of the plurality of slots;
performing, by a processing device, a yield optimization based on the responses to the bid requests to determine a creative for each of the plurality of slots that will optimize at least one of a payout or a value for the template; and
serving, to the user agent, the determined creative for each of the plurality of slots.

2. The method of claim 1, further comprising:
serving, to the user agent, the determined creative for each of the plurality of slots prior to receiving calls requesting creatives for all of the plurality of slots.

3. The method of claim 1, further comprising:
in response to receiving the call, determining whether an email comprising the template has previously been opened by the user agent.

4. The method of claim 3, further comprising:
if the email comprising the template has previously been opened by the user agent, determining what creative for each of the plurality of slots was previously sent to the user agent and serving the creative for each of the plurality of slots that was previously sent to the user agent.

5. The method of claim 1, further comprising:
presenting a template creation interface;
receiving the template defining the layout of the plurality of slots; and
assigning tags to each of the plurality of slots, the tags to uniquely identify each slot and associate each slot with the template.

6. The method of claim 5, further comprising:
associating the template with a piece of content, the content comprising at least one of an email, a webpage, a social media program or a mobile application.

7. The method of claim 1, wherein the template comprises an advertisement template.

8. A system comprising:
a memory to store a future decisioning module; and
a processing device operatively coupled to the memory, the processing device to execute the future decisioning module to:
receive, from a user agent, a call requesting a creative for a first slot of a plurality of slots in a template, the template defining a layout of the plurality of slots;
generate a bid request for each of the plurality of slots in the template;
receive, from one or more bidders, responses to the bid requests, each response comprising a price a bidder is willing to pay to display a creative in one of the plurality of slots;
perform a yield optimization based on the responses to the bid requests to determine a creative for each of the plurality of slots that will optimize at least one of a payout or a value for the template; and
serve, to the user agent, the determined creative for each of the plurality of slots.

9. The system of claim 8, wherein the future decisioning module further to:
serve, to the user agent, the determined creative for each of the plurality of slots prior to receiving calls requesting creatives for all of the plurality of slots.

10. The system of claim 8, wherein the future decisioning module further to:
in response to receiving the call, determine whether an email comprising the template has previously been opened by the user agent.

11. The system of claim 10, wherein the future decisioning module further to:
if the email comprising the template has previously been opened by the user agent, determine what creative for each of the plurality of slots was previously sent to the user agent and serve the creative for each of the plurality of slots that was previously sent to the user agent.

12. The system of claim 8, wherein the future decisioning module further to:
present a template creation interface;
receive the template defining the layout of the plurality of slots; and
assign tags to each of the plurality of slots, the tags to uniquely identify each slot and associate each slot with the template.

13. The system of claim 12, wherein the future decisioning module further to:
associate the template with a piece of content, the content comprising at least one of an email, a webpage, a social media program or a mobile application.

14. The system of claim 8, wherein the template comprises an advertisement template.

15. A non-transitory computer-readable storage medium storing instructions which, when executed, cause a processing device to perform operations comprising:
receiving, from a user agent, a call requesting a creative for a first slot of a plurality of slots in a template, the template defining a layout of the plurality of slots;
generating a bid request for each of the plurality of slots in the template;
receiving, from one or more bidders, responses to the bid requests, each response comprising a price a bidder is willing to pay to display a creative in one of the plurality of slots;
performing, by the processing device, a yield optimization based on the responses to the bid requests to determine a creative for each of the plurality of slots that will optimize at least one of a payout or a value for the template; and
serving, to the user agent, the determined creative for each of the plurality of slots.

16. The non-transitory computer-readable storage medium of claim 15, wherein the operations further comprise:
serving, to the user agent, the determined creative for each of the plurality of slots prior to receiving calls requesting creatives for all of the plurality of slots.

17. The non-transitory computer-readable storage medium of claim 15, wherein the operations further comprise:
in response to receiving the call, determining whether an email comprising the template has previously been opened by the user agent.

18. The non-transitory computer-readable storage medium of claim 17, wherein the operations further comprise:
if the email comprising the template has previously been opened by the user agent, determining what creative for each of the plurality of slots was previously sent to the user agent and serving the creative for each of the plurality of slots that was previously sent to the user agent.

19. The non-transitory computer-readable storage medium of claim 15, wherein the operations further comprise:
presenting a template creation interface;
receiving the template defining the layout of the plurality of slots; and
assigning tags to each of the plurality of slots, the tags to uniquely identify each slot and associate each slot with the template.

20. The non-transitory computer-readable storage medium of claim 19, wherein the operations further comprise:
associating the template with a piece of content, the content comprising at least one of an email, a webpage, a social media program or a mobile application.
